(19) United States
(12) Patent Application Publication
(10) Pub. No.: US 2015/0351996 A1
(43) Pub. Date: Dec. 10, 2015

(54) EXPANDABLE PRESSURE POINT MAT

(71) Applicants: Galina Bukharina, Austin, TX (US); Roger Borbon, Spicewood, TX (US)

(72) Inventors: Galina Bukharina, Austin, TX (US); Roger Borbon, Spicewood, TX (US)

(21) Appl. No.: 14/828,490

(22) Filed: Aug. 17, 2015

Related U.S. Application Data
(63) Continuation-in-part of application No. 13/626,283, filed on Sep. 25, 2012.

(51) Int. Cl. A61H 7/00

(52) U.S. Cl. CPC A61H 7/001; A61H 2201/1695; A61H 2201/0107

(57) ABSTRACT

A mat section can be connected to one or more additional mat sections to provide a desired size combination of the mat sections. One mat section can be used singly or interconnected with an adjacent one or more mat section by use of a connector member such that the adjacent mat sections can be connected together. Each mat section includes an array of pressure point fingers.

### CROSS-REFERENCE TO RELATED APPLICATIONS

This application is a continuation-in-part of U.S. application Ser. No. 13/626,283 filed on Sep. 25, 2012.

### BACKGROUND

Pressure point devices have been used to apply pressure to targeted areas of human tissue to relieve pain and provide therapeutic treatment by applying multiple pressure points to a given area of a body, such as a human body, without penetrating or harming the tissue. As a result, blood flow is increased to the pressure area thus stimulating a natural healing effect. The multiple pressure points can be provided as protrusions on a supporting mat. The protrusions can be in the form of a selected array of fingers formed of a suitable material. Such devices could also be used to provide therapeutic treatment to animals.

The mat can be of a size suitable to contact an area or a portion of the treated body, and several such mats can be used to provide an enlarged area. If the mat is of a relatively large size for contacting a large area of the body, that size may be inconvenient for carrying. If the mat is of a relatively small size, additional mats may be required to engage a targeted treatment area.

Accordingly, it would be advantageous to provide a mat which is of a size suitable to be expanded by joining with additional mats, and to be able to join multiple mats by means of a connector which permits one of the mats to be engaged with an adjacent one or more of the mats.

### SUMMARY

One embodiment accordingly, provides a mat section which can be used singly or connected to one or more additional mat sections to provide a desired size combination of the mat sections. One mat section can be interconnected with an adjacent mat section by use of a connector member such that the adjacent mat sections can be connected together. Each mat section includes an array of pressure point fingers.

### BRIEF DESCRIPTION OF THE DRAWINGS

FIG. 1 is a perspective view illustrating an embodiment of one side of a pressure point mat having a plurality of pressure point fingers.

FIG. 1a is an enlarged partial perspective view illustrating a portion of the mat of FIG. 1.

FIGS. 2a-2c are perspective views illustrating embodiments of various geometric shapes of the pressure point fingers, i.e. having an oval, a triangular and a rectangular base, respectively.

FIG. 3 is a perspective view illustrating an embodiment of a pressure point finger having a circular base and having a width dimension and a height dimension of the pressure point finger.

FIG. 4 is a side elevation view illustrating an embodiment of a force applied to a tip of a substantially rigid pressure point finger.

FIG. 5 is an enlarged partial cross-sectional side view illustrating an embodiment of the mat and a connector.

FIG. 6 is a cross-sectional view illustrating an embodiment of the connector for interconnecting adjacent mats.

FIG. 7 is a partial view illustrating an embodiment of the connector clamped on side-by-side edges of adjacent mats.

### DETAILED DESCRIPTION

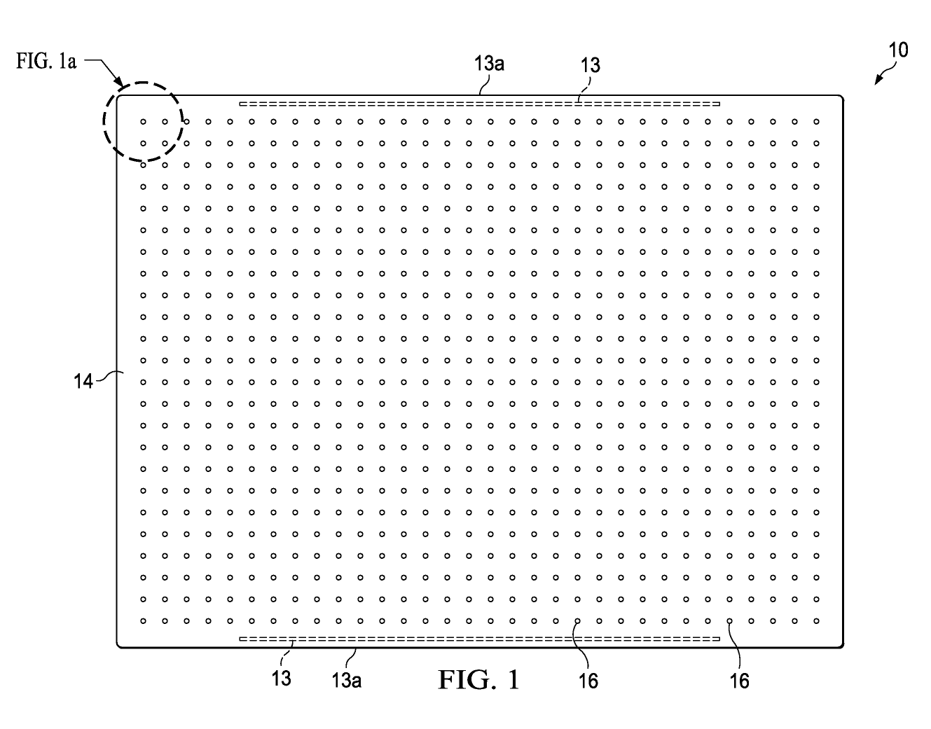

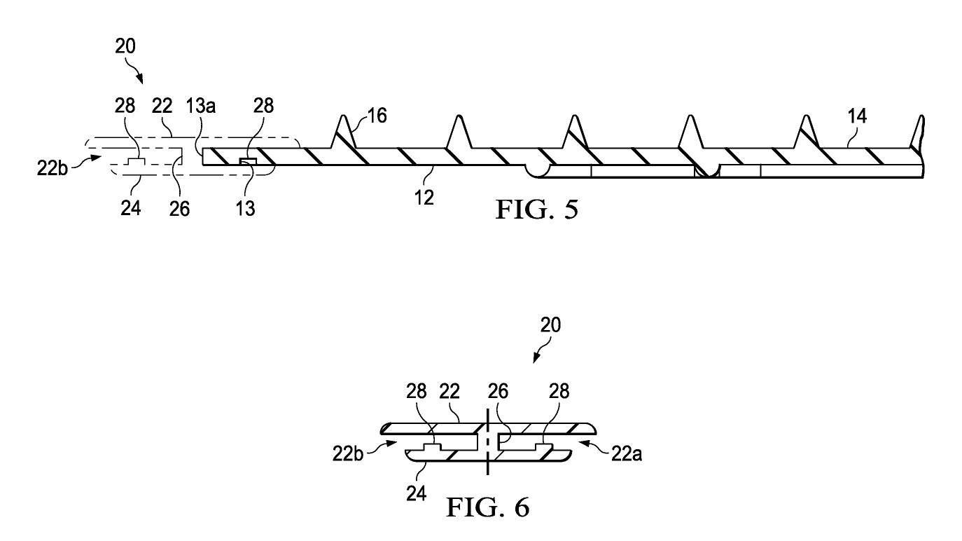

A therapeutic device includes a mat 10 having a first surface 12, FIGS. 1 and 5, and a second surface 14 opposite the first surface 12. A plurality of pressure point fingers 16 extend from the second surface 14 in a substantially dense array. The mat 10 and the pressure point fingers 16 are formed of a suitable synthetic material. The mat 10 and the fingers 16 are substantially rigid to resist flexing or distortion. An elongated groove 13 is formed in surface 12 along one or more edges 13a of mat 10. Each pressure point finger 16, see also FIG. 3, includes a tip 16a, a base 16b and a shaft 16c. The shaft 16c tapers outwardly from the tip 16a to the base 16b. The base 16b has a width dimension indicated as 16w, such that the base 16b is of a greater width than the tip 16a. Each shaft 16c has a height dimension 16h from the base 16b to the tip 16a. The height dimension 16h of each shaft 16c being fractionally greater than the width dimension 16w of the base 16b. However, both the height 16h and the width 16w are about 0.125 inches or less. Thus, the pressure point fingers 16 are substantially rigid to resist flexing. Each tip 16a is substantially tapered but is slightly rounded. This construction is sufficient to stimulate therapeutic treatment while resisting skin penetration.

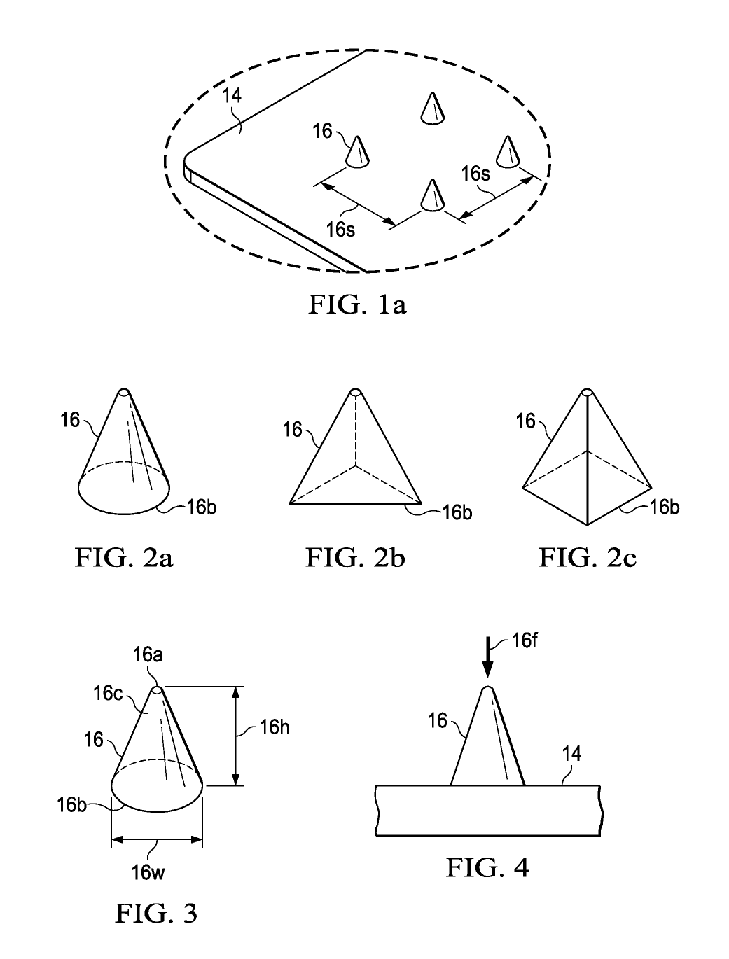

The pressure point fingers 16, see FIGS. 1a, 2a-c and 3-4, may be of varying geometry. For example, the pressure point finger 16 of FIG. 3, includes a base 16b having a circular cross-sectional shape, whereas the pressure point finger 16 of FIG. 2a includes a base 16b having an oval cross-sectional shape. In FIGS. 2b and 2c, the pressure point fingers 16 have a base 16b including a triangular cross-sectional shape and a rectangular cross-sectional shape, respectively. It is illustrated in FIG. 1a, that the pressure point fingers 16 are substantially equally spaced apart linearly and laterally as indicated by the similar distance dimensions 16s. Finally, as described above, the pressure point finger 16 of FIG. 4 illustrates the rigidity of each finger 16 enabling resistance to pressure acting thereon as indicated by a force designated 16f.

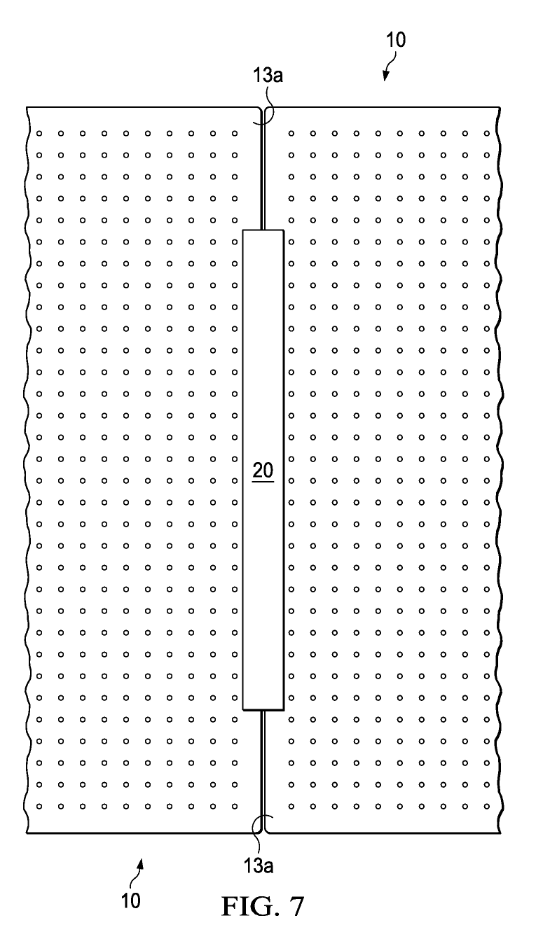

A connector 20, FIGS. 5, 6 and 7 is provided as a means for connecting an edge 13a of one mat 10 to an edge 13a of an adjacent mat 10. The connector 20 is preferably extruded and includes a first flange 22 and a second flange 24 connected to and spaced from the first flange 22 by means of a web 26. The first and second flanges 22, 24, respectively, form a pair of opposed gaps 22a, 22b on opposite sides of the web 26. The first flange 22 is of a greater width than the width of the second flange 24. The second flange 24 includes a pair of elongated ribs 28 extending into each gap 22a, 22b. The elongated ribs 28 may be replaced by a row of protrusions if desired, however, the continuous, elongated rib 28 is preferred.

Connection of a mat 10 to the connector 20 is best illustrated in FIG. 5. One gap 22b of connector 20 is shown empty to receive a mat 10, and the opposite gap is shown engaged with a mat 10. Groove 13 receives a rib 28 when the mat edge 13a nests against web 26. Manual pressure may be applied to either or both flanges 22, 24 to seat rib 28 into groove 13 in an interference fit for easy attachment and detachment.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A therapeutic apparatus, comprising:
a mat having an array of pressure point fingers, each finger extending from a surface of the mat;
each pressure point finger having a tip, a base and a shaft, the shaft tapering outwardly from the tip to the base, the base having a width dimension such that the base is of a greater width than the tip;
the tip being substantially tapered and including a sharply rounded edge;
the shaft of each finger having a height dimension from the base to the tip, the height dimension of each shaft being fractionally greater than the width of the base; and
the height dimension of each shaft not exceeding 0.125 inches, and the width of each base being less than 0.125 inches.

2. The apparatus of claim 1 wherein the base has a circular cross-sectional shape.

3. The apparatus of claim 1 wherein the base has an oval cross-sectional shape.

4. The apparatus of claim 1 wherein the base has a triangular cross-sectional shape.

5. The apparatus of claim 1 whereas the base has a rectangular cross-sectional shape.

6. The apparatus of claim 1 wherein each finger is substantially rigid.

7. A therapeutic apparatus, comprising:
a plurality of adjacent mats each having an array of pressure point fingers extending from a surface of each mat;
a connector for connecting an edge of a first one of the mats to an edge of a second mat;
each pressure point finger having a tip, a base and a shaft, the shaft tapering outwardly from the tip to the base, the base having a width dimension such that the base is of a greater width than the tip;
the tip being substantially tapered and including a sharply rounded edge;
the shaft of each finger having a height dimension from the base to the tip, the height dimension of each shaft being fractionally greater than the width of the base;
the height dimension of each shaft, not exceeding 0.125 inches, and the width dimension of each base being less than 0.125 inches; and
whereby, in an expanded mode, plural mats are positioned side-by-side exposing the pressure point fingers of each adjacent mat.

8. The apparatus of claim 7 wherein the base has a circular cross-sectional shape.

9. The apparatus of claim 7 wherein the base has an oval cross-sectional shape.

10. The apparatus of claim 7 wherein the base has a triangular cross-sectional shape.

11. The apparatus of claim 7 wherein the base has a rectangular cross-sectional shape.

12. The apparatus of claim 7 wherein each finger is substantially rigid.

13. The apparatus of claim 7 wherein at least one edge of each mat includes an elongated groove.

14. The apparatus of claim 13 wherein the connector includes a first flange and a second flange connected to and spaced apart from the first flange by a web, the web and the spaced apart flanges forming a pair of opposed first and second gaps on opposite sides of the web, each gap including a protruding elongated rib, whereby in response to the first gap of the connector receiving the at least one edge, a respective one of the grooves receives a respective one of the ribs.

15. The apparatus of claim 14 wherein an edge of an adjacent mat is received into the second gap of the connector, whereby the respective other groove of the adjacent mat receives the respective other rib.
